(19) United States
(12) Patent Application Publication
(10) Pub. No.: US 2015/0239107 A1
(43) Pub. Date: Aug. 27, 2015

(54) PIPE WRENCH WITH AN ADJUSTABLE HANDLE

(71) Applicant: Noah Sutton, West Long Branch, NJ (US)

(72) Inventor: Noah Sutton, West Long Branch, NJ (US)

(21) Appl. No.: 14/192,820

(22) Filed: Feb. 27, 2014

(51) Int. Cl. B25B 13/48; B25G 1/06; B25B 23/00; B25B 23/16; B25B 13/50; B25B 13/16

(52) U.S. Cl. CPC B25B 13/481; B25B 13/5058; B25B 13/16; B25B 23/0007; B25B 23/16; B25G 1/063

(57) ABSTRACT

A wrench, such as a pipe wrench, has an adjustable handle that allows a user to work past obstructions without requiring the user to remove the pipe wrench grips from an object. The wrench includes a wrench body having a typical pipe wrench adjustment mechanism. The wrench body further includes a slot through which a handle can be slid such that torque can be applied to the object secured by the wrench jaws through the handle when the handle is positioned above the jaws, below the jaws, or, for a two-handed, push-pull action, when the handle extends both above and below the jaws. The handle can have removable end caps, allowing the handle to be changed for various applications. Similarly, the upper jaw and lower jaw of the wrench can be removed and replaced for various applications.

### BACKGROUND OF THE INVENTION

The present invention relates to hand tools and, more particularly, to a pipe wrench having an adjustable handle that allows a user to easily work past obstructions.

Many hand tools used for gripping objects, such as pliers, wrenches, locking grips, and the like, have an integral handle or handles that extend from the gripping portion. The handles are designed to provide the user with leverage to permit enough torque to be applied to the object in order to, for example, turn the object.

It is often desirable, especially for hand tools that are used to turn objects that may be difficult to turn, to include a long handle, as the longer the handle, the more torque a user can provide to the object with the same amount of applied force.

However, as the handle length is increased, the functionality of the tool often decreases. Many times, as the object is turned with the tool, the handle will meet an obstruction and require the user to remove the tool from the object, reposition the tool and continuing turning. This can be time consuming and difficult, especially in confined spaces. Many times, the user has a difficult enough time initially placing the tool on the object, let alone having to remove and reset the tool one or more times.

As can be seen, there is a need for a gripping tool, such as a pipe wrench, that has an adjustable handle to allow the user to work past obstructions while turning an object with the tool

### SUMMARY OF THE INVENTION

In one aspect of the present invention, a tool comprises a tool body; an upper jaw slot disposed through the tool body; an adjustment control slot disposed through the tool body, the adjustment control slot intersecting the upper jaw slot; an upper jaw fitting into the upper jaw slot; an adjustment control fitting into the adjustment control slot and engaging with the upper jaw to provide an adjustment of the upper jaw relative to the tool body; a lower jaw disposed on the tool body; a handle slot disposed through the tool body; and a handle slidably disposed in the handle slot, wherein the handle can slide between a first position, with a majority of the handle extending above the tool body, and a second position, with the majority of the handle extending below the tool body.

In another aspect of the present invention, an adjustable wrench comprises a wrench body; an upper jaw slot disposed through the wrench body; an adjustment control slot disposed through the wrench body, the adjustment control slot intersecting the upper jaw slot; an upper jaw fitting into the upper jaw slot; an adjustment control fitting into the adjustment control slot and engaging with the upper jaw to provide an adjustment of the upper jaw relative to the wrench body; a lower jaw disposed on the tool body; a handle slot disposed through the wrench body; a handle slidably disposed in the handle slot, wherein the handle can slide between a first position, with a majority of the handle extending above the wrench body, and a second position, with the majority of the handle extending below the wrench body; and handle end caps disposed on opposite ends of the handle.

These and other features, aspects and advantages of the present invention will become better understood with reference to the following drawings, description and claims.

### BRIEF DESCRIPTION OF THE DRAWINGS

FIG. 1 is a partially exploded perspective view of a pipe wrench with an adjustable handle according to an exemplary embodiment of the present invention;

FIG. 2 is an exploded perspective view of the pipe wrench with an adjustable handle of FIG. 1;

FIG. 3 is a cross-sectional view taken along section 3-3 of FIG. 1; and

FIG. 4 is a cross-sectional view, also taken along section 3-3 of FIG. 1, but with the handle adjusted in alternative use position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wrench, such as a pipe wrench, having an adjustable handle that allows a user to work past obstructions without requiring the user to remove the pipe wrench grips from an object. The wrench includes a wrench body having a typical pipe wrench adjustment mechanism. The wrench body further includes a slot through which a handle can be slid such that torque can be applied to the object secured by the wrench jaws through the handle when the handle is positioned above the jaws, below the jaws, or, for a two-handed, push-pull action, when the handle extends both above and below the jaws. The handle can have removable end caps, allowing the handle to be changed for various applications. Similarly, the upper jaw and lower jaw of the wrench can be removed and replaced for various applications.

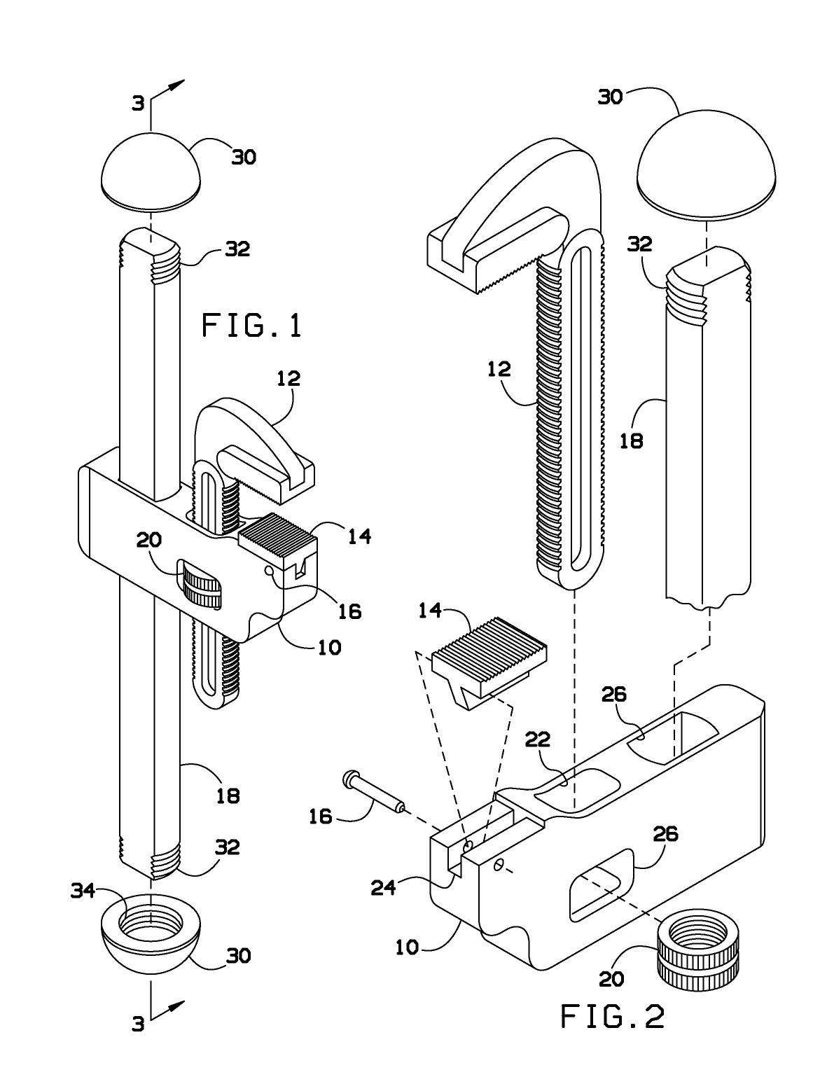

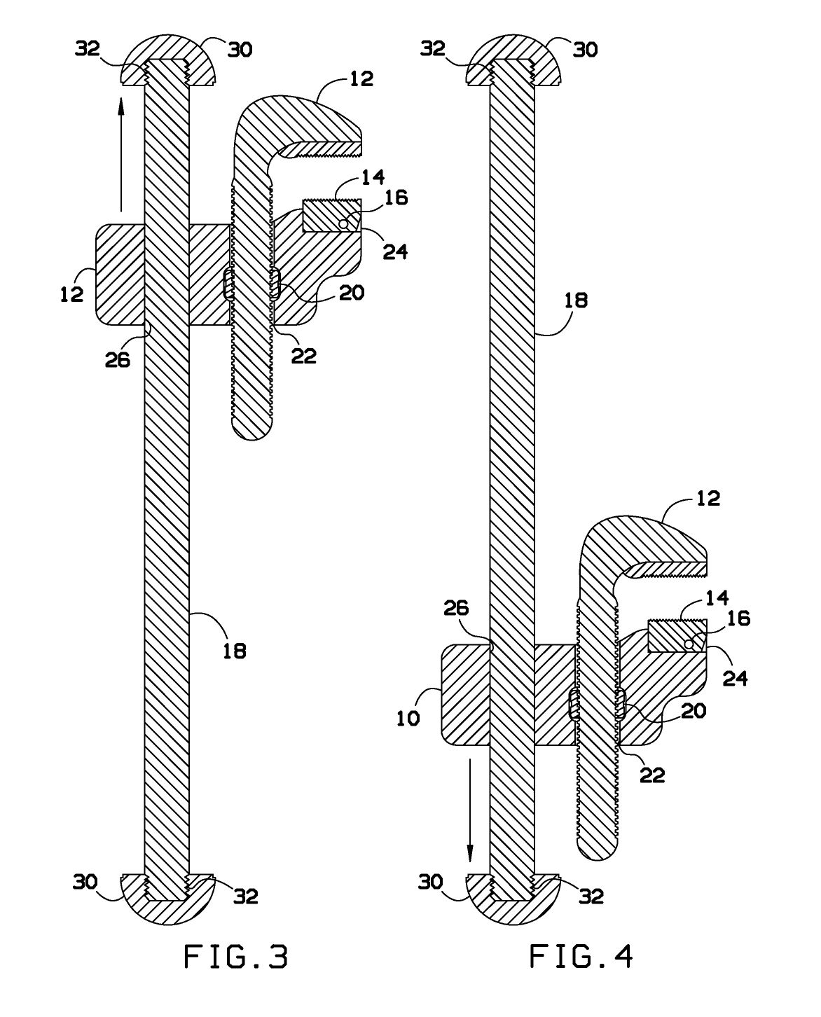

Referring now to FIGS. 1 through 4, a pipe wrench can include a wrench body 10 having a handle slot 26 formed through the wrench body 10. A handle 18 can be slid into the handle slot 26 and handle end caps 30 can be disposed on the handle 18. In some embodiments, ends of the handle can include handle threads 32 onto which handle end cap threads 34 of the handle end caps 30 can be removably disposed. In some embodiments, the handle end caps 30 can be fixed to the handle 18, and in other embodiments, the handle end caps 30 can be removable from the handle 18, allowing different handles to be used in the wrench body 10.

The handle 18 can be configured to change its position to accommodate the tool's function. Typically, the handle 18 is a long straight piece of material that can slide through the handle slot 26 in the wrench body 10. The handle 18 can be telescoping, compressing or bending, for example. Typically, the handle 18 is from about 6 to about 18 inches in length.

An upper jaw 12 can be disposed in a upper jaw slot 22 in the wrench body 10. Typically, the upper jaw slot 22 runs generally parallel to the handle slot 26. The upper jaw 12 can include threads 36 on at least one surface thereof. The upper jaw 12 and the lower jaw 14 can include a textured surface to assist in gripping objects.

An adjustment nut 20 can be disposed into an adjustment nut slot 28 that extends through the wrench body 10 generally perpendicular to and intersecting with the upper jaw slot 22. When the adjustment nut 20 is disposed in the adjustment nut slot 28, the upper jaw 28 can be placed into the upper jaw slot 22, allowing the upper jaw 28 to be threaded into the adjustment nut 20. Therefore, turning the adjustment nut 20 can cause the adjustment of the upper jaw 12 relative to the wrench body 10. The adjustment nut 20 can include an exterior texture to help the user turn the adjustment nut 20 to adjust the upper jaw 12. The adjustment nut 20 can be different from that shown, provided that the adjustment nut 20 can adjust the upper jaw 12 relative to the lower jaw 14. The adjustment nut 20 can be replaced with another adjustment and locking system, such as pins, cams, brackets, snaps, dovetails, keys, dials and the like.

A lower jaw 14 can be disposed on the wrench body 10 in various manners. For example, as shown in FIG. 2, the lower jaw 14 can be disposed in a lower jaw slot 24 formed in the wrench body 10 and secured in place via a lower jaw pin 16 inserted through the lower jaw 14 and the wrench body 10. Of course, other mechanisms for securing the lower jaw 14 to the wrench body 10 are contemplated within the scope of the present invention so long as the lower jaw 14 is disposed below a gripping portion of the upper jaw 12 so that an object can be secured between the upper jaw 12 and the lower jaw 14.

The wrench of the present invention can be formed in various sizes and shapes. A standard size could be, for example, about 18 inches long, but, of course, depending on application, this size can vary significantly.

The wrench of the present invention can be made from various materials. In some embodiments, the wrench can be made from metal, such as steel and titanium. Of course, the wrench may be made from other hard working materials, such as wood, other metals, plastic, or the like.

The wrench can be used in various ways. For example, if tightening a bolt in the center of a pipe, the user can adjust the opening between the upper jaw 12 and the lower jaw 14 via turning the adjustment nut 20 so that this opening fits the bolt. Once the user places the bolt between the jaws 12, 14, the user can turn the bolt by pulling or pushing on the handle 18. If an obstruction is reached, the user can simply move the handle 18 through the handle slot 26 so that it extends from the other end of the wrench body 10, allowing the user to continue to push or pull the handle 18 to turn the bolt, without having the remove the jaws 12, 14 from the bolt.

The wrench can be used by various types of users, including plumbers, electricians, construction workers, oil rig workers, mechanics, engineers, and the like.

While the drawings show a pipe wrench design, the tool of the present invention can be any such tool that can help rotate one object in relation with another with the leverage of a long handle.

It should be understood, of course, that the foregoing relates to exemplary embodiments of the invention and that modifications may be made without departing from the spirit and scope of the invention as set forth in the following claims.

What is claimed is:

1. A tool comprising:
a tool body;
an upper jaw slot disposed through the tool body;
an adjustment control slot disposed through the tool body, the adjustment control slot intersecting the upper jaw slot;
an upper jaw fitting into the upper jaw slot;
an adjustment control fitting into the adjustment control slot and engaging with the upper jaw to provide an adjustment of the upper jaw relative to the tool body;
a lower jaw disposed on the tool body;
a handle slot disposed through the tool body; and
a handle slidably disposed in the handle slot, wherein the handle can slide between a first position, with a majority of the handle extending above the tool body, and a second position, with the majority of the handle extending below the tool body.

2. The tool of claim 1, further comprising handle end caps disposed on opposite ends of the handle.

3. The tool of claim 2, wherein the handle end caps are removable from the handle.

4. The tool of claim 1, wherein the handle slot is generally parallel to the upper jaw slot.

5. The tool of claim 1, wherein the adjustment control slot is generally perpendicular to the upper jaw slot.

6. The tool of claim 1, wherein the adjustment control is a threaded nut mating with threads on the upper jaw.

7. The tool of claim 1, wherein the tool is an adjustable pipe wrench.

8. An adjustable wrench comprising:
a wrench body;
an upper jaw slot disposed through the wrench body;
an adjustment control slot disposed through the wrench body, the adjustment control slot intersecting the upper jaw slot;
an upper jaw fitting into the upper jaw slot;
an adjustment control fitting into the adjustment control slot and engaging with the upper jaw to provide an adjustment of the upper jaw relative to the wrench body;
a lower jaw disposed on the tool body;
a handle slot disposed through the wrench body;
a handle slidably disposed in the handle slot, wherein the handle can slide between a first position, with a majority of the handle extending above the wrench body, and a second position, with the majority of the handle extending below the wrench body; and
handle end caps disposed on opposite ends of the handle.

9. The adjustable wrench of claim 8, wherein the handle end caps are removable from the handle.

10. The adjustable wrench of claim 8, wherein:
the handle slot is generally parallel to the upper jaw slot; and
the adjustment control slot is generally perpendicular to the upper jaw slot.
